(19) United States
(12) Patent Application Publication
(10) Pub. No.: US 2024/0023603 A1
(43) Pub. Date: Jan. 25, 2024

(54) CASE FOR AN AEROSOL DELIVERY DEVICE

(71) Applicant: Nicoventures Trading Limited, LONDON (GB)

(72) Inventor: Mohsin MASIH-UD-DIN, London (GB)

(21) Appl. No.: 18/257,370

(22) PCT Filed: Dec. 13, 2021
(86) PCT No.: PCT/GB2021/053259

§ 371 Date: Jun. 14, 2023

(30) Foreign Application Priority Data
Dec. 14, 2020 (GB) 2019674.7

(51) Int. Cl. A24F 15/01; A24F 40/51; A24F 40/95; H01M 10/46; H01M 10/48; H01M 10/42

(52) U.S. Cl. CPC A24F 15/01; A24F 40/51; A24F 40/95; H01M 10/46; H01M 10/488; H01M 10/4257; H01M 2220/30; H01M 2010/4278

(57) ABSTRACT

A case for an aerosol delivery device, and a method for using the case, is described and can include a lid having an open position and a closed position; a detector configured to provide a lid signal indicative of whether the lid is open or closed; and a controller configured to activate diagnostics depending on the lid signal. The controller may be configured to activate first diagnostics when the lid signal indicates a change from lid being open to the lid being closed.

### PRIORITY CLAIM

The present application is a National Phase Entry of PCT Application No. PCT/GB2021/053259, filed Dec. 13, 2021, which claims priority from GB Application No. 2019674.7, filed Dec. 14, 2020, each of which are hereby fully incorporated by reference.

### TECHNICAL FIELD

The present specification relates to a case (e.g. a carry case), in particular a case for an aerosol delivery device.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol provision substrate such as tobacco to form an aerosol by heating, but not burning, the substrate. An aerosol delivery device may be provided with a case, such as a carry case, for retaining the device when not in use. There remains a need for further developments in this field.

### SUMMARY

In a first aspect, this specification describes a case for an aerosol delivery device (which aerosol delivery device may, for example, comprise a tobacco heating system), the case comprising: a lid having an open position and a closed position; a detector configured to provide a lid signal indicative of whether the lid is open or closed; and a controller configured to activate diagnostics depending on the lid signal. The detector may comprise a switch. A change in the lid position may, for example, be indicated by a sensor, such as said switch.

The controller may be configured to active first diagnostics when the lid signal indicates a change from lid being open to the lid being closed. The first device diagnostics may include one or more of: device health diagnostics; session data; and fault information. Alternative, or in addition, the controller may be configured to active second diagnostics when the lid signal indicates a change from lid being closed to the lid being open. The second device diagnostics may include one or more of: battery charge level; and device readiness.

The case may further comprise a display for providing information relating to diagnostics. The display may comprise one or more light emitting diodes.

The case may further comprise a communications module for providing two-way communications with a user device or remote application. The communication module may communicate one or more of a change in the lid position and an output of diagnostics to said user device or remote application. Alternatively, or in addition, the communication module may receive instructions relating to the operation of the case from the user device or remote application.

The aerosol delivery device may be a non-combustible aerosol generating device.

The case may further comprise the aerosol delivery device. The aerosol delivery device nay be configured to receive a removable article comprising an aerosol generating material. The aerosol generating material may comprise an aerosol generating substrate and an aerosol forming material.

In a second aspect, this specification describes a method comprising: obtaining a lid signal indicative of whether a lid of a case of an aerosol delivery device is in an open position or a closed position; and activating diagnostics depending on the lid signal.

Activating said diagnostics may comprise activating first diagnostics when the lid signal indicates a change from lid being open to the lid being closed. The first device diagnostics may include one or more of: device health diagnostics; session data; and fault information. Alternatively, or in addition, activating said diagnostics may comprise activating second diagnostics when the lid signal indicates a change from lid being closed to the lid being open. The second device diagnostics may include one or more of: battery charge level; and device readiness.

The method may further comprise displaying information relating to diagnostics.

The method may further comprise communicating one or more of a change in the lid position and an output of diagnostics to a user device or remote application.

The method may further comprise receiving instructions relating to the operation of the case from a/the user device or remote application.

The method may further comprise receiving the aerosol delivery device within the case.

In a third aspect, this specification describes a kit of parts comprising a case as described above with reference to the first aspect, an aerosol delivery device and an article for use in the aerosol delivery device. The aerosol delivery device may be a non-combustible aerosol provision device. The article may be a removable article comprising an aerosol generating material.

### BRIEF DESCRIPTION OF THE DRAWINGS

Example embodiments will now be described, by way of example only, with reference to the following schematic drawings, in which:

FIG. 1 shows a case for an aerosol delivery device in accordance with an example embodiment.

FIG. 2 is a block diagram of a non-combustible aerosol delivery device in accordance with an example embodiment.

FIGS. 3 and 4 are flow charts showing algorithms in accordance with example embodiments.

FIGS. 5 and 6 block diagrams of systems in accordance with example embodiments.

FIGS. 7 and 8 are block diagrams of displays in accordance with example embodiments.

FIG. 9 is a block diagram of a system in accordance with an example embodiment.

FIGS. 10 and 11 show displays of a user device or application in accordance with example embodiments.

### DETAILED DESCRIPTION

As used herein, the term “aerosol delivery device” is intended to encompass systems that deliver a substance to a user, and includes:
non-combustible aerosol provision systems that release compounds from an aerosolizable material without combusting the aerosolizable material, such as electronic cigarettes, tobacco heating products, and hybrid systems to generate aerosol using a combination of aerosolizable materials; and
articles comprising aerosolizable material and configured to be used in one of these non-combustible aerosol provision systems.

According to the present disclosure, a “combustible” aerosol provision system is one where a constituent aerosolizable material of the aerosol provision system (or component thereof) is combusted or burned in order to facilitate delivery to a user.

According to the present disclosure, a “non-combustible” aerosol provision system is one where a constituent aerosolizable material of the aerosol provision system (or component thereof) is not combusted or burned in order to facilitate delivery to a user.

In embodiments described herein, the delivery system is a non-combustible aerosol provision system, such as a powered non-combustible aerosol provision system.

In one embodiment, the non-combustible aerosol provision system is an electronic cigarette, also known as a vaping device or electronic nicotine delivery system (END), although it is noted that the presence of nicotine in the aerosolizable material is not a requirement.

In one embodiment, the non-combustible aerosol provision system is a tobacco heating system, also known as a heat-not-burn system.

In one embodiment, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In one embodiment, the hybrid system comprises a liquid or gel aerosolizable material and a solid aerosolizable material. The solid aerosolizable material may comprise, for example, tobacco or a non-tobacco product.

Typically, the non-combustible aerosol provision system may comprise a non-combustible aerosol provision device and an article for use with the non-combustible aerosol provision system. However, it is envisaged that articles which themselves comprise a means for powering an aerosol generating component may themselves form the non-combustible aerosol provision system.

In one embodiment, the non-combustible aerosol provision device may comprise a power source and a controller. The power source may be an electric power source or an exothermic power source. In one embodiment, the exothermic power source comprises a carbon substrate which may be energized so as to distribute power in the form of heat to an aerosolizable material or heat transfer material in proximity to the exothermic power source. In one embodiment, the power source, such as an exothermic power source, is provided in the article so as to form the non-combustible aerosol provision.

In one embodiment, the article for use with the non-combustible aerosol provision device may comprise an aerosolizable material, an aerosol generating component, an aerosol generating area, a mouthpiece, and/or an area for receiving aerosolizable material.

In one embodiment, the aerosol generating component is a heater capable of interacting with the aerosolizable material so as to release one or more volatiles from the aerosolizable material to form an aerosol. In one embodiment, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic means.

In one embodiment, the aerosolizable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolizable material in order to achieve a physiological response other than olfactory perception. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In some embodiments, the active substance comprises nicotine. In some embodiments, the active substance comprises caffeine, melatonin or vitamin B12.

The aerosol forming material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more functional materials may comprise one or more of flavors, carriers, pH regulators, stabilizers, and/or antioxidants.

In one embodiment, the article for use with the non-combustible aerosol provision device may comprise aerosolizable material or an area for receiving aerosolizable material. In one embodiment, the article for use with the non-combustible aerosol provision device may comprise a mouthpiece. The area for receiving aerosolizable material may be a storage area for storing aerosolizable material. For example, the storage area may be a reservoir. In one embodiment, the area for receiving aerosolizable material may be separate from, or combined with, an aerosol generating area.

Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In some embodiments, the aerosolizable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it.

The aerosolizable material may be present on a substrate. The substrate may, for example, be or comprise paper, card, paperboard, cardboard, reconstituted aerosolizable material, a plastics material, a ceramic material, a composite material, glass, a metal, or a metal alloy.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

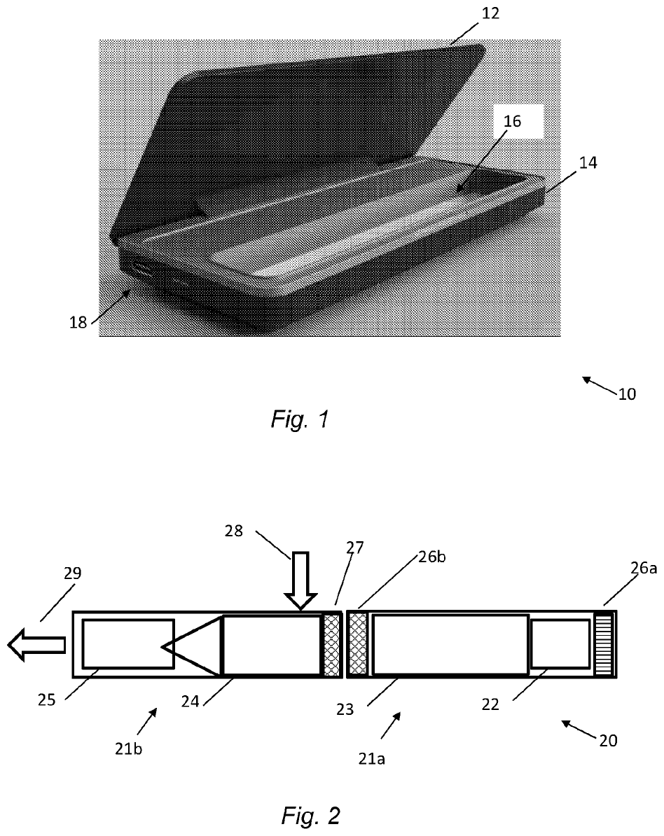

FIG. 1 shows a case for an aerosol delivery device, indicated generally by the reference numeral 10 in accordance with an example embodiment. The case 10 comprises a lid 12 and a main body 14. The main body 14 includes a storage area 16 for storing an aerosol delivery device (not shown in FIG. 1). The aerosol delivery device may be a non-combustible aerosol generating device, although this is not essential to all example embodiments.

The case 10 includes a port 18 that may be used for charging a battery of an aerosol delivery device stored in the storage area 16.

FIG. 2 is a block diagram of a non-combustible aerosol delivery device, indicated generally by the reference numeral 20, in accordance with an example embodiment. The aerosol delivery device 20 may be stored within the area 16 of the case 10 described above. The device 20 is a modular device, comprising a first part 21a and a second part 21b. In some embodiments, the first part 21a and the second part 21b may be stored separately in the case 10 (e.g. detached from one another). The aerosol delivery device 20 may comprise a tobacco heating system.

The first part 21a of the device 20 includes a control circuit 22 and a battery 23. The second part 21b of the device 20 includes a heater 24 and a liquid reservoir 25 (that may collectively form an aerosol generator).

The first part 21a includes a first connector 26a (such as a USB connector). The first connector 26a may enable connection to be made to a power source (e.g. a battery of the case 10 or an external power supply via the port 18 of the case 10) for charging the battery 23, for example under the control of the control circuit 22.

The first part 21a also includes a second connector 26b that can be removably connected to a first connector 27 of the second part 21b.

In the use of the device 20, air is drawn into an air inlet of the heater 24, as indicated by the arrow 28. The heater is used to heat the air (e.g. under the control of the circuit 23). The heated air is directed to the liquid reservoir 25, where an aerosol is generated. The aerosol exits the device at an air outlet, as indicated by the arrow 29 (for example into the mouth of a user of the device 20).

The liquid reservoir 25 may be provided by a removable article comprising an aerosol generating material. The aerosol generating material may comprise an aerosol generating substrate and an aerosol forming material.

It should be noted that the device 20 is described by way of example only. Many alternative devices could be stored within the case 10 in accordance with example embodiments.

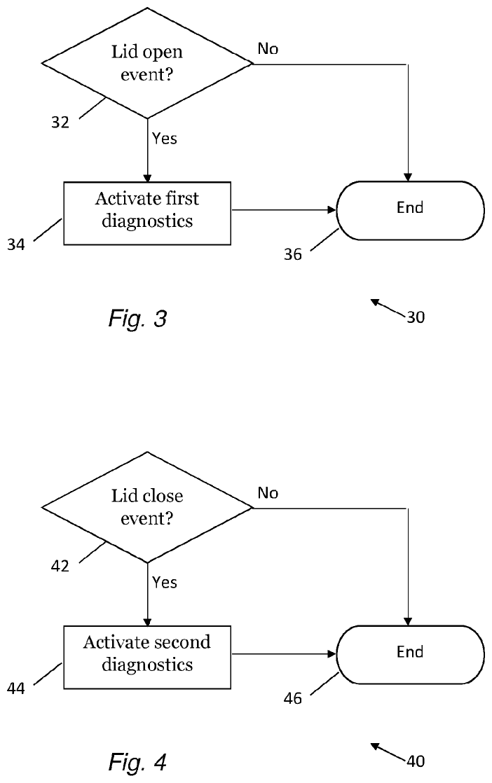

FIG. 3 is a flow chart showing an algorithm, indicated generally by the reference numeral 30, in accordance with an example embodiment.

The algorithm 30 starts at operation 32, where a determination is made regarding whether the lid 12 of the case 10 has been opened. If not, the algorithm 30 moves to operation 36 where the algorithm 30 terminates.

If it is determined in the operation 32 that the lid has been opened, then the algorithm 30 moves to operation 34 where first diagnostics are performed. Example diagnostics are discussed further below.

Similarly, FIG. 4 is a flow chart showing an algorithm, indicated generally by the reference numeral 40, in accordance with an example embodiment.

The algorithm 40 starts at operation 42, where a determination is made regarding whether the lid 12 of the case 10 has been closed. If not, the algorithm 40 moves to operation 46 where the algorithm 40 terminates.

If it is determined in the operation 42 that the lid has been closed, then the algorithm 40 moves to operation 44 where second diagnostics are performed. Example diagnostics (which may be partially or totally different to the first diagnostics referred to above) are discussed further below.

Of course, the algorithms 30 and 40 shown in FIGS. 3 and 4 are highly schematic and may be implemented in many different ways. For example, the algorithms 30 and 40 may be implemented as interrupt routines, wherein the detection of the lid changing from a closed state to the opened state or vice-versa triggers the relevant diagnostics. Moreover, one or other of the algorithms 30 and 40 may be omitted; thus diagnostics may be performed when the lid is opened (algorithm 30) but not when it is closed (algorithm 40), or vice-versa.

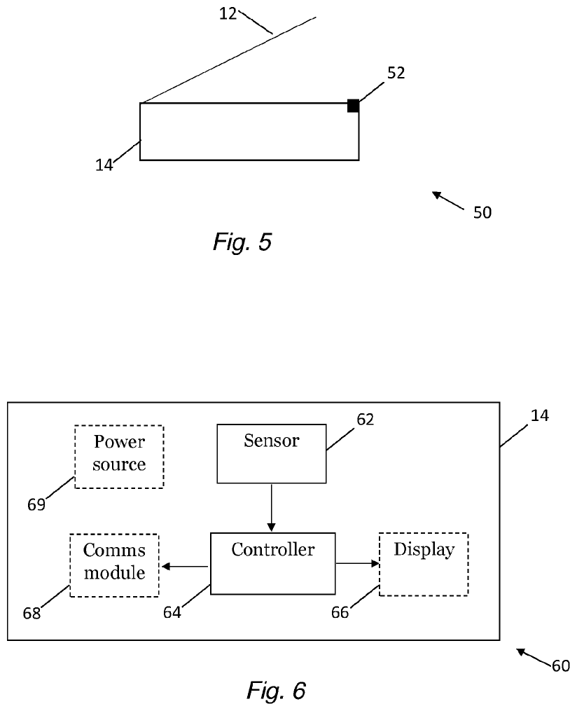

FIG. 5 is a block diagram of a system, indicated generally by the reference numeral 50, in accordance with an example embodiment.

The system 50 shows the lid 12 and the main body 14 of the case described above. The system 50 also shows a switch 52 that is used to determine when the lid 12 is opened or closed. The switch 52 is one example of many arrangements for determining whether the lid 12 is opened or closed. Other examples include a magnet/hall sensor pairs or the detection of an impedance change. The skilled person will be aware of many alternative arrangements that could be used.

FIG. 6 is a block diagram of a system, indicated generally by the reference numeral 60, in accordance with an example embodiment. The system 60 comprises a sensor 62, a controller 64, a display 66, a communication module 68 and a power source 69 that are provided within the main body 14 of the case 10. The display 66, communication module 68 and power source 69 are shown in dotted form as one or more (or all) of those modules may be omitted in some example embodiments.

The sensor 62 provides a signal to the controller 64 indicative of whether the lid is open or closed. The switch 52 described above is one example implementation of the sensor 62 but, as noted above, many alternatives (such as the use of a hall sensor/magnet pair) are possible.

The controller 64 is configured to activate diagnostics depending on the lid signal. For example, the controller 64 may be configured to activate first diagnostics when the lid signal indicates a change from lid being closed to the lid being open. Alternatively, or in addition, the controller 64 may be configured to activate second diagnostics when the lid signal indicates a change from lid being open to the lid being closed. Thus, the controller 64 may implement the algorithm 30 and/or the algorithm 40 described above.

The first and second diagnostics may take many forms. Moreover, the first and second diagnostics may be the same, partially the same or different.

By way of example, examples of the first diagnostics (performed when the lid is opened) include: device health diagnostics; session data; and fault information. Examples of the second diagnostics include: battery charge level; and device readiness.

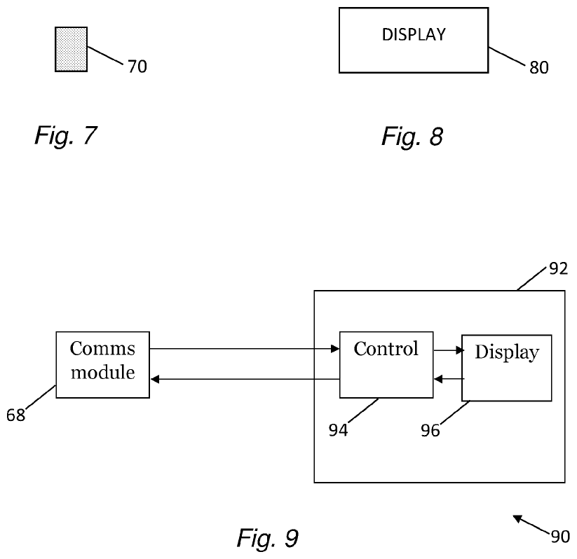

The system 60 may comprise a display 66 for providing information relating to diagnostics. FIGS. 7 and 8 are block diagrams of displays in accordance with example embodiments.

Specifically, FIG. 7 shows a light-emitting diode (LED) 70 that may be used to provide diagnostics information. For example, in response to the lid 12 of the case 10 being opened and/or closed, the LED 70 may be selectively illuminated to provide information relating to the relevant diagnostics. The LED 70 may, for example, have different colors to provide different status indications. Moreover, a plurality of LEDs may be provided to enable further information to be provided.

FIG. 8 shows a display 80 that might enable more information than the LED 70 to be presented. For example, the display 80 may enable text and/or images to be presented.

The system 60 may include a communication module 68. The communications module may enable diagnostics information to be sent to an external module (such as a user device or an application, as discussed further below). The communication module 68 may be provided in addition to, or instead of, the display 66, thereby providing different mechanisms for communicating diagnostics information to a user.

The system 60 may include a power source 69 (such as a battery) to provide power to the various elements within the main body of the case 10. In some example embodiments, the battery 23 of an aerosol delivery device 20 mounted within the storage area 16 of the case 10 may be used to power the elements within the main body of the case in addition to, or instead of, the power source 69. Indeed, in some example embodiments, the power source 69 may be omitted.

FIG. 9 is a block diagram of a system, indicated generally by the reference numeral 90, in accordance with an example embodiment. The system 90 comprises the communication module 68 described above and further comprises a user device (or remote application) 92. The user device 92 includes a control module 94 and a display 96.

The control module 94 may determine whether and how to display message received from the communication module 68 to a user using the display 96.

A user may also provide input, such as instructions, using the display 96 or otherwise, which input is provided to the control module 94. The control module 94 can then provide user instructions to the communication module 68, thereby establishing two-way communications between the controller 64 and the control module 94.

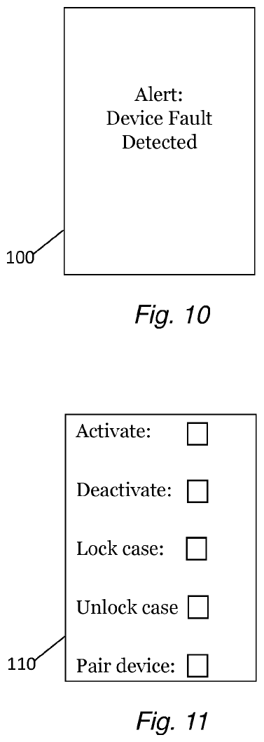

FIG. 10 shows a display, indicated by the reference numeral 100, of a user device or application in accordance with an example embodiment. The display 100 is an example output of the display 96 described above.

The display 100 provides a simple message a user: “Alert: Device Fault Detected”. By way of example, the message may be displayed in response to the detection of a fault during a device diagnostics algorithm.

FIG. 11 shows a display, indicated by the reference numeral 110, of a user device or application in accordance with an example embodiment. The display 110 is an example output of the display 96 described above. The display 110 shows examples of control inputs that might be made available to a user, for example via an application.

The example control inputs shown in the display 110 are:
Activate. The device may be activated by the user.
Deactivate. The device may be deactivated by the user. For example, a user might want to deactivate the device to save power, or in the event that they are not in possession of the device.
Lock case. This feature might be particularly useful if the user is not in possession of the device and might want to prevent others from opening the case.
Unlock case.
Pair device. Pairing a user device or an application with the case may enable the case to communicate only with the paired user device or remote application.

Messages may be sent to a remote application or user device for many other reasons in addition to, or instead of, the examples provided above. For example, if an unexpected event occurs, such as a failure to charge the device or a fault is detected, the user may be alerted.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the claims or limitations on equivalents to the claims, and that other embodiments may be utilized and modifications may be made without departing from the scope of the claims. Various embodiments of the disclosure may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A case for an aerosol delivery device, the case comprising:
a lid having an open position and a closed position;
a detector configured to provide a lid signal indicative of whether the lid is open or closed; and
a controller configured to activate diagnostics depending on the lid signal.

2. The case as claimed in claim 1, wherein the controller is configured to activate first diagnostics when the lid signal indicates a change from the lid being open to the lid being closed.

3. The case as claimed in claim 2, wherein the first diagnostics include one or more of:
device health diagnostics;
session data; or
fault information.

4. The case as claimed in claim 1, wherein the controller is configured to activate second diagnostics when the lid signal indicates a change from the lid being closed to the lid being open.

5. The case as claimed in claim 4, wherein the second diagnostics include one or more of:
battery charge level; or
device readiness.

6. The case as claimed in claim 1, wherein the detector comprises a switch.

7. The case as claimed in claim 1, further comprising a display for providing information relating to the diagnostics.

8. The case as claimed in claim 7, wherein the display comprises one or more light emitting diodes.

9. The case as claimed in claim 1, further comprising a communications module for providing two-way communications with a user device or a remote application.

10. The case as claimed in claim 9, wherein the communication module communicates one or more of a change in the lid position or an output of diagnostics to the user device or the remote application.

11. The case as claimed in claim 9, wherein the communication module receives instructions relating to operation of the case from the user device or the remote application.

12. The case as claimed in claim 1, wherein the aerosol delivery device is a non-combustible aerosol generating device.

13. The case as claimed in claim 1, further comprising the aerosol delivery device.

14. The case as claimed in claim 13, wherein the aerosol delivery device is configured to receive a removable article comprising an aerosol generating material.

15. The case as claimed in claim 14, wherein the aerosol generating material comprises an aerosol generating substrate and an aerosol forming material.

16. The case as claimed in claim 1, wherein the aerosol delivery device comprises a tobacco heating system.

17. A method comprising:
obtaining a lid signal indicative of whether a lid of a case of an aerosol delivery device is in an open position or a closed position; and
activating diagnostics depending on the lid signal.

18. The method as claimed in claim 17, wherein activating the diagnostics comprises activating first diagnostics when the lid signal indicates a change from the lid being open to the lid being closed.

19. The method as claimed in claim 18, wherein the first diagnostics include one or more of:
device health diagnostics;
session data; or
fault information.

20. The method as claimed in claim 17, wherein activating the diagnostics comprises activating second diagnostics when the lid signal indicates a change from the lid being closed to the lid being open.

21. The method as claimed in claim 20, wherein the second diagnostics include one or more of:
battery charge level; or
device readiness.

22. The method as claimed in claim 17, further comprising displaying information relating to the diagnostics.

23. The method as claimed in claim 17, further comprising communicating one or more of a change in the lid position and an output of diagnostics to a user device or a remote application.

24. The method as claimed in claim 17, further comprising receiving instructions relating to the operation of the case from a user device or a remote application.

25. The method as claimed in claim 17, further comprising receiving the aerosol delivery device within the case.

26. A kit of parts comprising the case as claimed in claim 16, an aerosol delivery device and an article for use in the aerosol delivery device.

27. The kit of parts as claimed in claim 26, wherein the aerosol delivery device is a non-combustible aerosol generating device.

28. The kit of parts as claimed in claim 26, wherein the article is a removable article comprising an aerosol generating material.
